(19) United States
(12) Patent Application Publication
(10) Pub. No.: US 2017/0286376 A1
(43) Pub. Date: Oct. 5, 2017

(54) Checking Grammar Using an Encoder and Decoder

(71) Applicant: Jonathan Mugan, (US)

(72) Inventor: Jonathan Mugan, (US)

(21) Appl. No.: 15/086,056

(22) Filed: Mar. 31, 2016

(51) Int. Cl. G06F 17/22; G06F 17/27; G06F 17/24

(52) U.S. Cl. CPC G06F 17/2288; G06F 17/24; G06F 17/277

(57) ABSTRACT

The present invention is a method and apparatus, including computer programs encoded on computer storage media, for checking grammar in text. An edit generator and edit scorer are provided. The edit generator creates edited versions of the text that are scored by the edit scorer. The edit scorer provides an encoder and a decoder. The encoder converts the text into an abstract representation that is used by the decoder to score edited versions of the text. The invention can also be used as a thesaurus and idiom finder, generating alternatives to words and phrases, and scoring their viability. The invention can also correct text in queries for items.

### CROSS-REFERENCE TO RELATED APPLICATIONS

This application claims the benefit of PPA Ser. No. 62/141,837, filed 2015 Apr. 1 by the present inventors, which is incorporated by reference.

### TECHNICAL FIELD

The present invention relates to grammar checking of text.

### BACKGROUND ART

There are grammar checking tools for finding mistakes in grammar in text, but they could be improved. Unlike spell checking, grammar checking is difficult. You can't just write down the rules of English grammar and check that they are followed like you can when building a compiler for a programming language. Natural languages such as English have some syntactic regularity, but they are squishy.

There are four current approaches to grammar checking:
1. Language model: Treat words as symbols and compute the probability of the next word, and use that probability to help determine if the correct word was written.
2. Phrase-based machine translation.
3. Rule-based approaches.
4. Machine learning classifiers for specific error types.

These methods typically work by treating words as symbols, so that “car” and “automobile” are two different symbols, even though they generally play the same role in grammar.

### BRIEF SUMMARY

A system and method for checking grammar of text that encodes the text to be checked in an abstract representation and then uses a decoder to check the plausibility of potential edits. The present invention also acts as a thesaurus, idiom finder. The present invention can also correct text in queries for items.

### BRIEF DESCRIPTION OF THE DRAWINGS

FIG. 1 depicts the high-level process of grammar checking.

FIG. 2 depicts how windows of text are processed.

FIG. 3 depicts a text window.

FIG. 4 depicts how text is converted into a sequence of text windows.

FIG. 5 depicts the edit generator.

FIG. 6 depicts the edit scorer.

FIG. 7 depicts the encoder-decoder.

FIG. 8 depicts how the encoder-decoder is trained.

### DETAILED DESCRIPTION OF SPECIFIC EMBODIMENTS

### Advantages

The present invention represents text to be checked using an abstract representation consisting of vectors, which serve as an abstraction that encodes the underlying meaning and grammatical function of the text. Such an abstract representation, for example, allows “I have a cat” and “I have a dog” to be represented similarly. This similarity is useful for checking grammar.

### First Embodiment

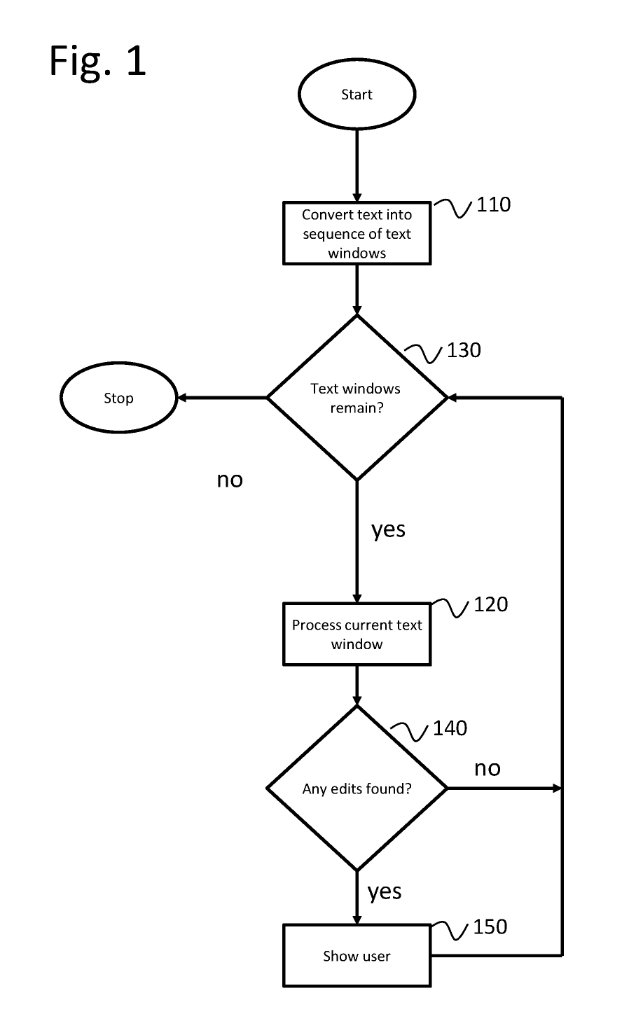

### FIG. 1: Perform High-Level Process

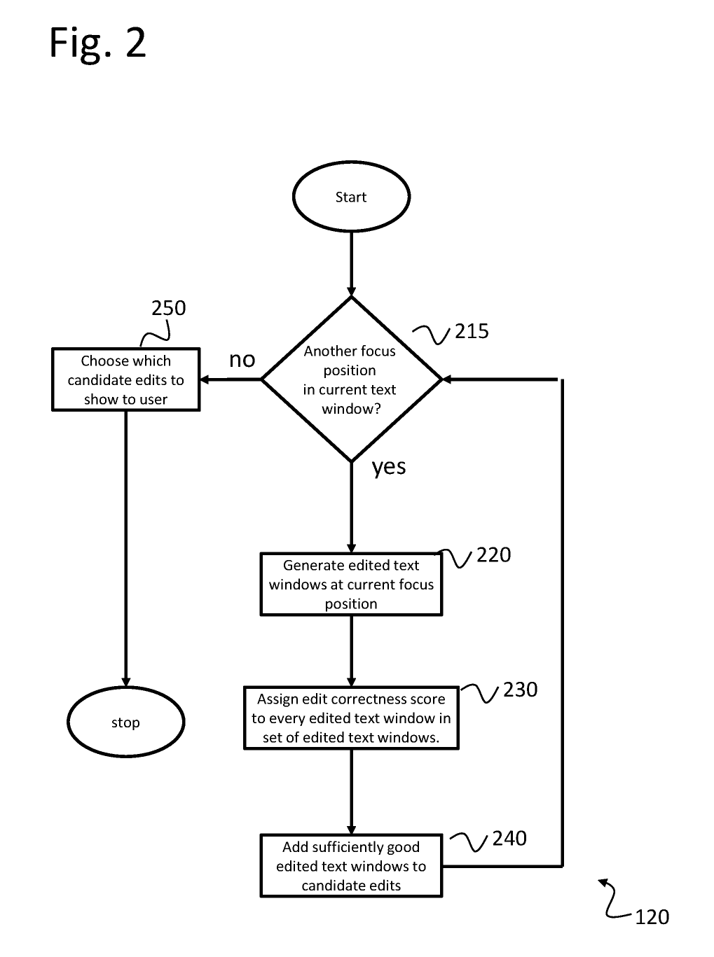

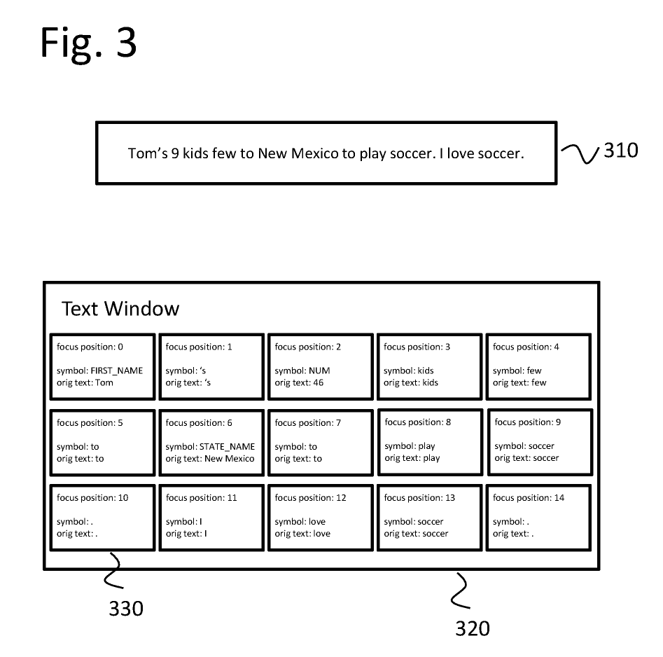

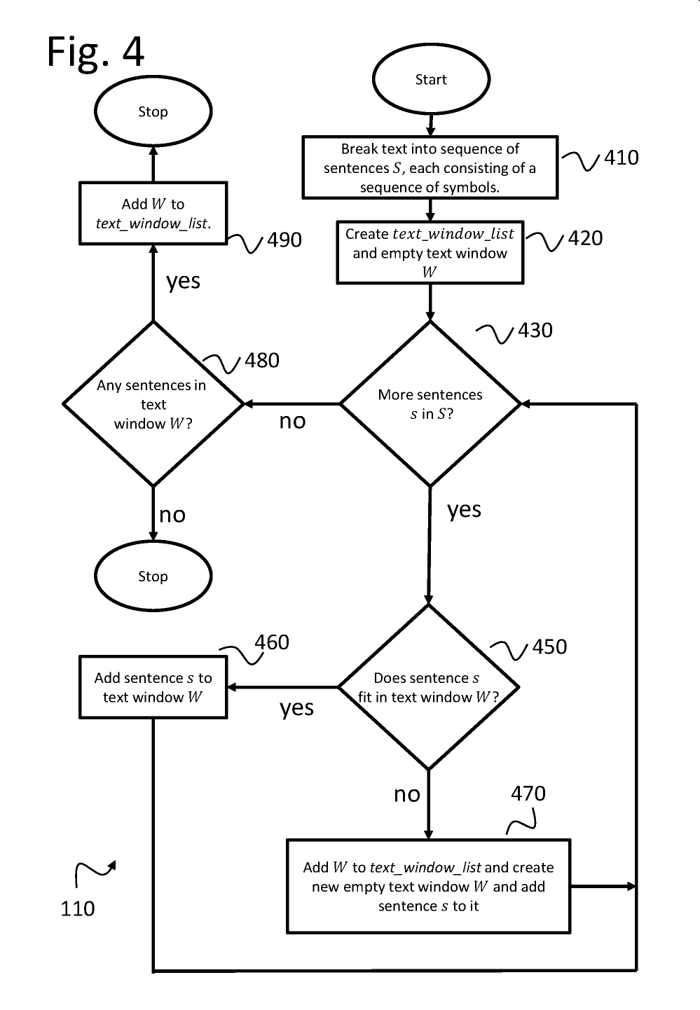

FIG. 1 shows the high-level process. The user submits text to the system to be checked, and in step 110 the invention breaks the text into a sequence of text windows (detailed in FIGS. 3 and 4), with each text window consisting of a small number of sentences. Step 130 determines whether more text windows remain to be processed. If so, the next text window is called the current text window, and step 120 (detailed in FIG. 2) processes the current text window to identify potential edits. Step 140 determines if any edits are found, and if so, step 150 shows those edits to the user so that he or she can make possible corrections.

### FIG. 2: Process Current Text Window

The invention computes potential edits for each focus position in each text window. An edit is some change to the text to make it more likely to be correct. FIG. 2 shows how the current text window is processed to search for potential edits.

Step 215 determines whether there are any more focus positions in the current text window, if there are, the next focus position is called the current focus position, and step 220 generates edits at the current focus position, step 230 scores any edits found, and step 240 adds sufficiently good edits to a set of candidate edits. After all focus positions have been examined, step 250 determines which candidate edits to show to the user. Details are given presently.

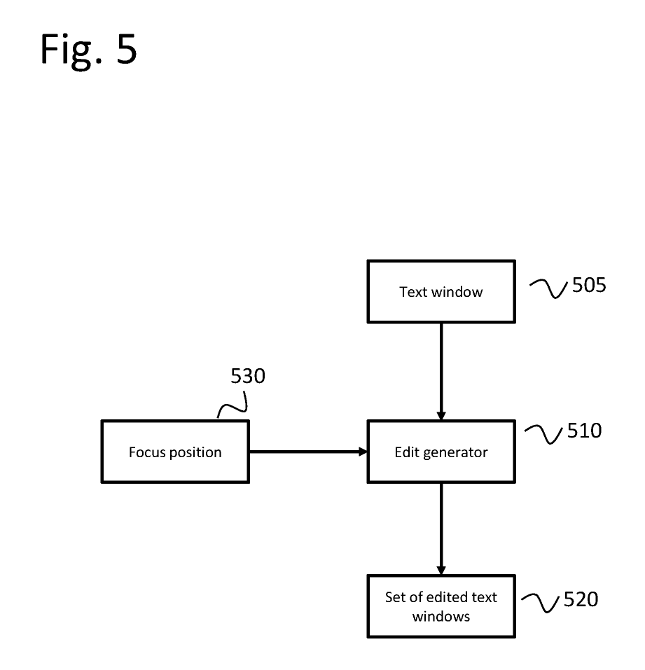

Step 220 calls the edit generator 510 of FIG. 5 to generate edited versions of the text in the form of a set of edited text windows 520 at the current focus position for the current text window. Each edited text window corresponds to an edit.

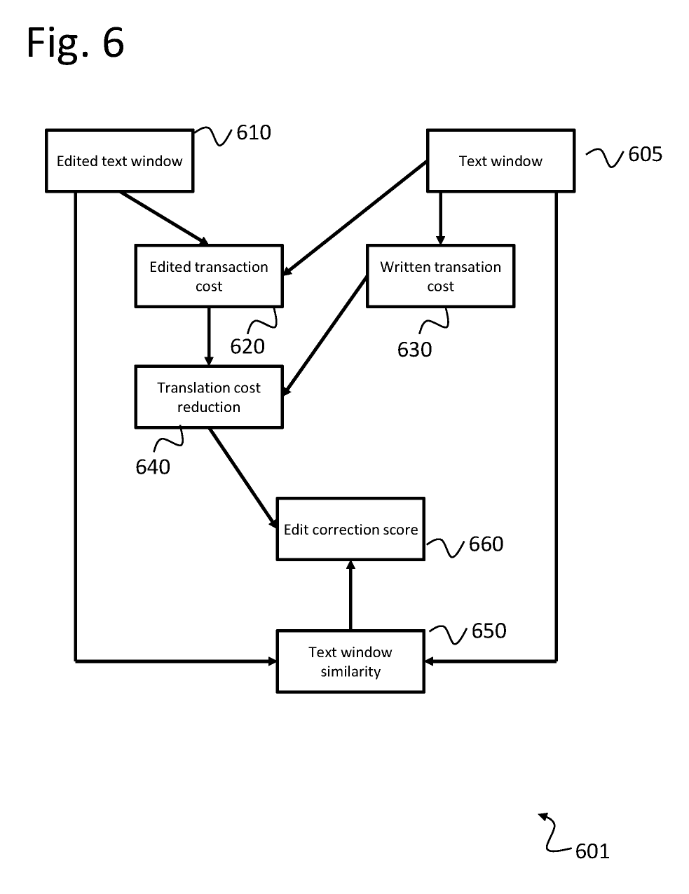

Step 230 assigns an edit correction score 660 to each edited text window in the set of edited text windows 520. Step 230 assigns this score by looping through each edited text window in the set of edited text windows 520 and for each edited text window, called the current edited text window, step 230 calls the edit scorer 601 of FIG. 6 setting the edited text window 610 to be the current edited text window and the text window 605 to be the current text window.

Step 240 adds any edit with a sufficiently high edit correction score 660 to the set of candidate edits. In an embodiment, the step 240 can also filter edits based on predefined thresholds for translation cost reduction 640 and text window similarity 650. Step 240 can optionally allow a user to influence these thresholds through one or more parameters.

Step 250 chooses which edits to show to a user. In an embodiment, the system can show the edit to the user with the highest edit correction score 660, or it can show the user all edits that exceed some threshold on the edit correction score 660, or it can show the user all of the edits with an edit correction score 660 within some percentage of the highest edit correction score 660, or it can use some other method to show edits.

### FIG. 3: A Text Window

A text window 320 is a unit of analysis generally representing one or a small number of sentences. Each text window 320 contains a maximum number of symbols, where symbols roughly correspond to tokens. For example, the sentence “I love to run.” would have the tokens “I”, “love”, “to”, “run”, “.”. Tokenization can be done using standard software such as the Natural Language Toolkit (NLTK) software library. Converting tokens to symbols may be done (but not necessarily) by lowercasing the tokens. For example, the token “I” would be converted to the symbol “i”. There may be some fixed number of symbols, possibly 50,000, that make up the vocabulary. Any token that cannot be mapped to a symbol may be given the special symbol “UNK.”

Each symbol corresponds to a focus position 330 in the text window 320. A focus position 330 is a data structure that contains the symbol and the associated text. For example, if the text were “I” and the symbol were “i” the focus position would contain both. The maximum number of focus positions (and thus symbols) allowed in a text window is pre-specified by the parameter max_focus_positions (in an embodiment, one possible value for this parameter is 100). When converting the text into a sequence of text windows, the idea is to load up each text window with as many sentences as will fit. The result is that there will be no more text windows for a text than there are sentences in the text. In practice there will generally be fewer text windows in the text than sentences because each text window can potentially hold more than one sentence.

A symbol in a focus position 330 can optionally encompass more than one word when those words form an atomic concept such as a city name. Consider the example in FIG. 3. Item 310 is the text “Tom's 46 kids few to New Mexico to play soccer. I love soccer.” In FIG. 3, we see that the text 310 is captured by a single text window that has 15 focus positions. Each focus position contains a symbol and the original text that led to that symbol.

Converting multiple tokens into a single symbol can be done using something like Stanford RegexNer or by looking ahead up to some fixed number of tokens when converting tokens to symbols. For example, the invention may convert “New York City” to a single focus position with the symbol “city” and the text “New York City.” Atomic concepts can also be found using named entity recognition, such as the Stanford Named Entity Recognizer.

FIG. 4: Convert Text into Sequence of Text Windows

FIG. 4 shows how the invention breaks up the text into a sequence of text windows.

Step 410 breaks the text into a sequence of sentences S using a standard sentence tokenizer, such as the one available with the Natural Language Toolkit (NLTK) software library. Step 410 then converts each sentence into a sequence of symbols. Step 410 makes sure that no sentence has more than max_focus positions focus positions. In the unlikely event that a sentence does have more than max_focus_positions, step 410 can split a sentence in some way, such as in the middle.

Step 420 creates an empty sequence text_window_list and an empty text window W. Step 430 determines if there are more sentences in S left to process. If so, it grabs the next sentence s from S.

Step 450 determines if the current sentence s will fit in the current text window W. If the number of symbols in sentence s plus the number of focus positions in text window W is less than or equal to max_focus_positions, step 460 adds sentence s to the current text window W by making each symbol in sentence s a focus position in text window W.

If the sentence s does not fit in text window W, this means that text window W is full, and step 470 adds text window W to text_window_list. Step 470 then creates a new empty text window W and adds sentence s to it.

When all of the sentences have been processed, step 480 determines whether text window W has any sentences in it. If so, step 490 adds text window W to text_window_list.

The result of this process is that the text is converted to text windows represented by text_window_list.

### FIG. 5: The Edit Generator

The edit generator 510 generates a set of edited text windows 520 for a text window 505 and a given focus position 530. Each edited text window represents an edited version of the text in text window 505. For example, if text window 505 corresponds to the sentence “Our brains our not perfect.” and the given focus position 530 is the third position, the edit generator 510 may create an edited text window that is just like text window 505 but with the symbol “our” replaced with the symbol “are” in the third focus position. This edited text window would be added to the set of edited text windows 520.

The edit generator 510 can use any kind of way to create edits by changing the text window 505. For concreteness, we outline six different edit types in an embodiment.
1. Replace the symbol at focus position 530 with another one. One can use a heuristic method such as beam search to find good candidates. Beam search stores the best few candidates (or “beams”) as it moves through all of the focus positions. This notion of “best” is computed as translation cost in the encoder-decoder 740.
2. Insert a symbol before focus position 530. Again, one can use a heuristic method such as beam search to find good candidates.
3. Delete focus position 530.
4. Swap the symbols in focus position 530 and the next focus position, if not the last.
5. Concatenate text at focus position 530 and the next focus position, if not the last. For example, if focus position 530 has the symbol “may” corresponding to the text “may” and the next focus position has the symbol “be” corresponding to the text “be”, one can remove these two focus positions and replace them with a single focus position with the symbol “maybe” with the corresponding text “maybe”.
6. Special pre-specified corrections, such as replacing focus position 530 with the text and symbol “their” with a focus position with the text and symbol “there”. In another example, one could replace focus position 530 if it had the symbol and text “its” with two focus positions, the first with the symbol and text “it” and the second with the symbol and text “'s”.

### FIG. 6: The Edit Scorer

The present invention attempts to generate edited text that is more likely than the text but is close to the text. Because of this, the edit scorer 601 scores potential edits by combining the translation cost reduction 640 with text window similarity 650 into the edit correction score 660. The combining can be done in an embodiment by a linear combination, in one embodiment this linear combination can take the form of the correction score 660 being equal to translation cost reduction 640 plus text window similarity 650.

One can view the encoder-decoder 740 as computing the cost of translating one text window into another. Translation cost reduction 640 measures how much easier it is to translate a text window into an edited text window than to translate the text window back to itself. Translation cost reduction 840 is generated by the equation

$$translation cost reduction 640 = \frac{written translation cost 630 - edited translation cost 620}{written translation cost 630}$$

The written translation cost 630 is the translation cost 745 computed by the encoder-decoder 740 if one sets the text window 705 and the edited text window 760 to be the text window 605.

The edited translation cost 620 is the translation cost 745 computed by the encoder-decoder 740 if one sets the text window 705 to be the text window 605 and sets the edited text window 760 to be the edited text window 610.

Text-window similarity 650 can be computed using any way that computes the difference of two texts, such as the number of characters that are different, called the edit distance or the Levenshtein distance. The text-window similarity 650 can be 1.0 minus this or some other measure of the difference of two texts. In an embodiment, one can compute the text-window similarity based on the type of edit. For example, for insert, one can consider the edited text window 610 to be more similar to the text window 605 if a common word was inserted than if an uncommon word is inserted, even if those two words resulted in the same character difference between texts. For example, an edited text window 610 made by inserting the text “and” could be more similar to the a text window 605 than an edited text window 610 made by inserting the text “arc”, since “and” is a more common word than “arc”. The idea behind using the commonality of a word is that a user is more likely to omit a common word than an uncommon word. Analogous logic can be applied when deleting a focus position. An edited text window 610 made by deleting a common word should have a higher text-window similarity 650 than an edited text window 610 made by deleting an uncommon word, with the reasoning being that a user is more likely to accidently insert a common word than an uncommon world.

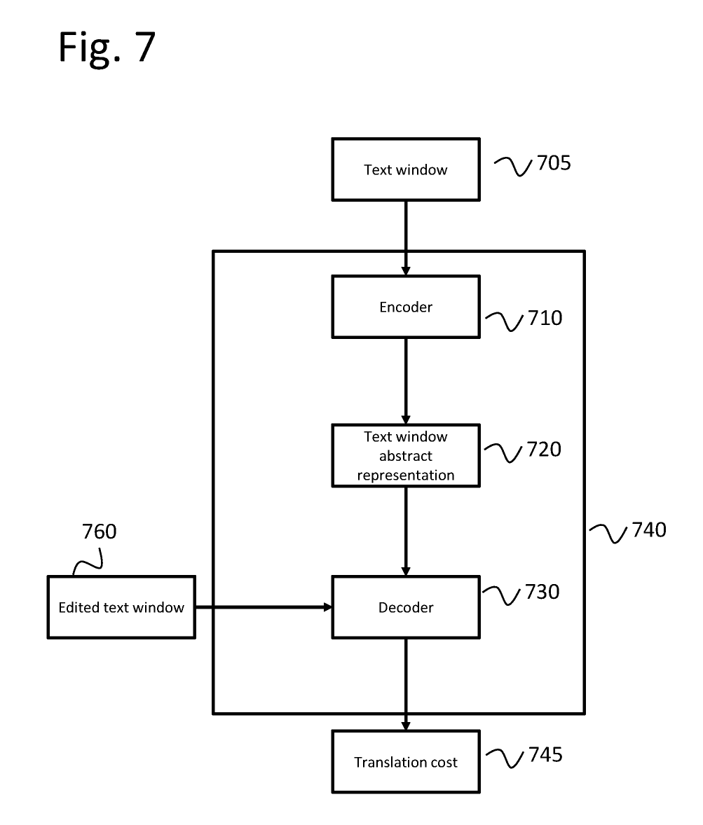

### FIG. 7: The Encoder-Decoder

The encoder-decoder 740 is a function that takes a text window 705 and an edited text window 760 and outputs a translation cost 645 indicating how likely it is that the edited text window 760 is the correct text. The lower the translation cost 745, the more likely it is that the edited text window 760 is the correct text.

The encoder 710 consists of a parametric function ƒₑ that learns an encoding from a text window 705 to a text window abstract representation 720. A parametric function is one that has a set of parameters that are learned or tuned. This text window abstract representation 720 can take the form of a vector or a sequence of vectors. The parametric function ƒₑ of the encoder 720 can take the form of a recurrent neural network (RNN) or a complex recurrent neural network (such as an LSTM), or some other parametric function. We represent ƒₑ as

hₑ^{t}=ƒₑ(hₑ^{t-1},xₜ)

where xₜ is the symbol at focus position t in the text window 705 and hₑ^{t} is the state of the encoder 710 at focus position t. The state hₑ^{t} is represented as a vector or sequence of vectors. The initial state hₑ⁰ (assuming the first focus position is 1) can be initialized to a vector of 0s or some other initial value. Then, if we let T be the number of focus positions in the text window 705, we can let the text window abstract representation 720 be represented by c and let be c=hₑ^{T}, or some parametric function of hₑ^{T}. Note that in other embodiments, the text window abstract representation 720 represented by c can be the sequence hₑ⁰, hₑ¹, hₑ², . . . , hₑ^{T} some function of the sequence hₑ⁰, hₑ¹, hₑ², . . . , hₑ^{T}.

The decoder 730 consists of two parametric functions ƒ_{d} and g_{d}. If we represent the text window abstract representation 720 as c, the state of the decoder as at focus position t as hₑ^{t}, and the symbol at focus position t of the edited text window 760 as y^{t}, we can represent the state update function ƒ_{d} of the decoder 730 as

h_{d}^{t}=ƒ_{d}(h_{d}^{t-1},y^{t-1},c)

where the superscript t indicates which focus position of the edited text window 760 the decoder is currently processing. As with hₑ⁰, we can initialize h_{d}⁰ to be a vector of 0s or some other value, and we can specify y⁰ to be an arbitrary start symbol such as “<S>”. The function ƒ_{d} can take the form of an RNN, LSTM, or some other parametric function.

To compute a distribution over correct symbols at focus position t, the decoder 730 uses function g_{d}(h_{d}^{t}, y^{t-1}, c). Function g_{d}(h_{d}^{t}, y^{t-1}, c) gives a probability score for each symbol at focus position t in the edited text window 760. The function g_{d} can output a distribution by taking the form of a softmax function. Both functions ƒ_{d} and g_{d} are parametric functions. If the text window abstract representation 720 represented by c is the sequence hₑ⁰, hₑ¹, hₑ², . . . , hₑ^{T} or some function of that sequence, the decoder 730 can also use a learned attention mechanism so that it learns to determine how much emphasis to give each hₑ^{t} when computing the distribution over symbols using g_{d} for a particular h_{d}^{t} and y^{t-1}.

The transition cost 745 of translating the symbols in the text window 705 to the symbols in the edited text window 760 is the sum of the negative log of each probability of each symbol in the edited text window 760 at its focus position t. This cost is computed by looping over all of the focus positions in the edited text window 760, and for each focus position t getting the probability of the symbol at focus positon t and taking the negative log of it, and summing all of those values up.

For concreteness, we provide one exemplary embodiment of the encoder-decoder 740 functions ƒₑ, ƒ_{d}, and g_{d}. For the encoder 710

hₑ^{t}=ƒₑ(hₑ^{t-1},xₜ)=tan h(Wₑhₑ^{t-1}+Vₑxₜ)

Where Wₑ is a matrix of parameters that gets multiplied by the vector hₑ^{t-1}, and Vₑ is a matrix of parameters where each column represents a vector that represents a symbol. In this formulation, xₜ the current symbol of the text window 705 is represented as a one-hot vector (a vector with zeros everywhere except for one place) so that when multiplied by Vₑ the vector for that symbol comes out. For example, if the symbol for xₜ is “cat”, this can correspond to the third value of xₜ being 1, so that the third column of Vₑ is used, per the rules of multiplying a matrix by a vector. The function tan h is a nonlinear function common in neural networks (there are many possible nonlinear functions such as a sigmoid).

For the decoder 730, we could have

h_{d}^{t}=ƒ_{d}(h_{d}^{t-1},c)=tan h(W_{d1}h_{d}^{t-1}+V_{d}y^{t-1}+W_{d2}c)

Where c=hₑ^{T} is a vector and yₜ₋₁ is a one-hot representation of the last symbol in the edited text window 760 and W_{d1}, V_{d}, and W_{d2} are matrices of parameters.

If we let d_{g}(y^{t}; h_{d}^{t}, y^{t-1}, c) indicate the probability that the function g_{d}(h_{d}^{t}, y^{t-1}, c) assigns to symbol y^{t} in the edited text window 760, and if we consider an embodiment of g_{d} that does not use y^{t-1} and c directly (it still uses then indirectly via h_{d}^{t} coming from ƒ_{d}), we can represent

$$Pr ( {y}^{t} \vert {h}_{d}^{t} , {y}^{t - 1} , c ) = {ℊ}_{d} ( {y}^{t} ; {h}_{d}^{t} , {y}^{t - 1} , c ) = \frac{exp ( {w}_{i} {h}_{d}^{t} )}{{\sum }_{j ∈ v} exp ( {w}_{j} {h}_{d}^{t} )}$$

Where V is the set of all symbols in the vocabulary, and the summation loops over all of them by their index j so that wⱼ is the vector from a parameter matrix W_{d3} corresponding to the symbol j. Likewise, wᵢ is the vector from parameter matrix W_{d3} corresponding to the symbol y^{t} at focus position t in the edited text window 760, and exp(x) means e^{x}. An embodiment could include y^{t-1} and c in g_{d} by using h_{d}^{t}, y^{t-1}, and c as inputs into a another neural network with its own parameters, and it could take the dot product of the output of that network with wᵢ (likewise for the other symbols with wⱼ) as the argument into exp.

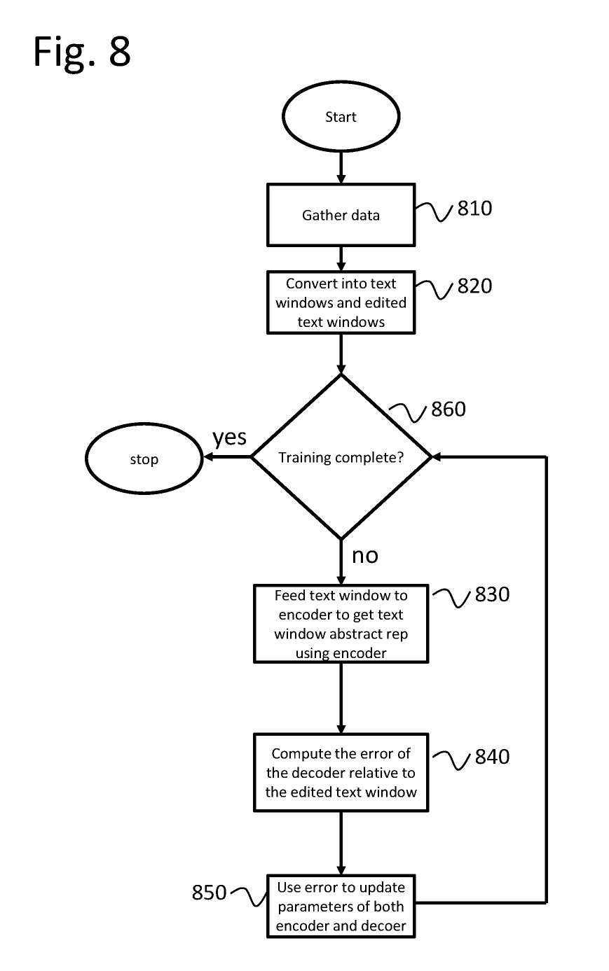

In this exemplary embodiment, the parameter values that need to be learned are contained in the matrices Wₑ, W_{d1}, W_{d2}, W_{d3}, Vₑ, and V_{d}. The way these parameters are learned is described in FIG. 8, discussed next.

### FIG. 8: Training the Encoder-Decoder

Training of the encoder-decoder 740 can be done either with unlabeled data or labeled data. Labeled data is a set of text windows that have been corrected by an individual or some process. In the labeled case, the text window 705 is what the author originally wrote, and the edited text window 760 is text that has been corrected. For unlabeled data, each text window 705 is what the author originally wrote, and the edited text window 760 is the same as the original text window 705. The idea behind using unlabeled data is that as long as most authors are correct most of the time, the encoder-decoder 740 can still learn to correct text. For example, one could train on unlabeled data by downloading Wikipedia and training on that.

Step 810 is to gather training data. This data can consist of a large number of documents of text or snippets of text.

Step 820 is to convert the data into pairs, each consisting of a text window and corresponding edited text window, where the edited text window is assumed to be correct. The purpose of training is to teach the machine to map the text windows to the edited text windows. If the training data is documents of text, they must first be converted to text windows, as shown in step 110.

Step 860 determines if training is complete. Training continues until a stopping criterion, such as a fixed number of time steps. If training is not complete, step 830 gets the next pair of text windows, consisting of a text window 705 and its corresponding edited text window 760, and it feeds the text window 705 to the encoder 710 to get the text window abstract representation 720.

Step 840 computes the translation cost 745 of the edited text window 760 by feeding it through the decoder 730. We are training on pairs where the edited text window 760 is assumed to be the correct version of the text window 705. Training is by gradient descent, or some other optimization method, on an error function. This error function can be cross entropy. Cross entropy is −log y for a value y, which means that it computes the error of the symbol at focus position t in the edited text window 760 as the negative log of the probability of that symbol given by function g_{d}(h_{d}^{t}, y^{t-1}, c) of the decoder 730.

Step 850 uses that error function to update the parameters of all of the parametric functions in the encoder 710 and decoder 730. This update is done using gradient descent or some other optimization method. Gradient descent iteratively updates the parameter values by changing them in the opposite direction of the gradient of the error function. This gradient can be computed through backpropagation.

Backpropagation computes the gradient of the error function relative to the parameters of the functions of the encoder 710 and decoder 730. In an embodiment, the equation used to update the each parameter w can be w←w−α∇E(w) where α is a scale parameter set to some small value, such as 0.2, and ∇E(w) is the gradient of the error function relative to parameter w. We saw that the error function E can be cross entropy in an embodiment, and this error comes as a result of the function g_{d} and since function g_{d} has h_{d}^{t} as an argument, the cost function links the output of function g_{d} with the output of function ƒ_{d}(h_{d}^{t-1}, y^{t-1}, c) And since function ƒ_{d} has c as an argument (function g_{d} has c as an argument as well), the cost function also links all the way back to the encoder function ƒₑ because c is its output at time T (recall that c=hₑ^{T}). Using this linkage of equations, backpropagation computes the value ∇E(w) for each parameter w using the chain rule of computing derivatives. Backpropagation can be implemented by anyone with sufficient skill in the art and can even be done automatically using Theano or TensorFlow.

This training process can also be done in batch with multiple pairs at a time. The particular method for updating the encoder-decoder parameters through backpropagation is not relevant to the invention.

### Alternative Embodiment: Using a Document Context Abstract Representation

In an alternative embodiment, the invention can use a representation of the entire text, called a document context abstract representation, when computing translation cost reduction 640. The document context abstract representation is an abstract representation of the entire text to be checked, and, like the text window abstract representation 720, can be a vector or a sequence of vectors, or some other structure of vectors.

In FIG. 1, in step 110, the invention can convert the entire text into a document context abstract representation. The document context abstract representation can be created using Skip-Thought or some other method.

The document context abstract representation can then be fed into the decoder 730 along with the text window abstract representation 720 and the edited text window 760. The document context abstract representation can be integrated into the invention by integrating it into the computation for ƒ_{d} and g_{d}. If we use d to represent the document context abstract representation, we can modify ƒ_{d} to be

h_{d}^{t}=ƒ_{d}(h_{d}^{t-1},y^{t-1},c,d)

And we can modify g_{d} to be

g_{d}(h_{d}^{t},y^{t-1},c,d)

to give the probability distribution over the symbols for focus position t.

During training of the encoder-decoder 740 described in FIG. 8, the document context abstract representation must be computed for each training text and must be computed and fed into the decoder 730 for training pairs associated with that text.

The document context abstract representation can alternatively encode all of the text for a particular user so that the grammar checker is customized for that user. This could be done by taking all of the text for a user and treating it as a single text.

### Alternative Embodiment: Perturbing the Edited Text Window

In step 220 in the unlabeled training case, the invention can perturb the text windows so that text window 705 has errors and the edited text window 760 is the original text window. This can be done to simulate learning from labeled data. In an alternative embodiment, the present invention creates errors that are similar to errors that humans make.

To create errors by replacing words, the present invention can make those replacements based on word similarity. Before training begins, the invention creates a word replace model based on word similarity. For each word in the vocabulary, it computes the distance, for example by using the Levenshtein distance, between that word and every other word in the vocabulary. Then when a word is replaced during perturbation, the invention replaces words with similar words instead of completely randomly. This makes it more likely that the word “cart” will be replaced by “car” than “salad.” Similarly, for inserting words into random locations in sentences, the invention computes the probability of each word before training by counting the frequency of words in some corpus. Then when perturbing the text windows during training, the invention is more likely to insert a common word than an uncommon word, making the mistake similar to how a human would make such a mistake.

### Alternative Embodiment: Parsing to Improve Descriptions

In an alternative embodiment, the edit scorer 601 can use a parser to help score edited text windows. The edit scorer 601 can parse the edited text window 610 and decrease the edit correction score 660 for an edited text window 610 that it is unable to parse or can parse only with difficulty. Alternatively, it can increase the edit correction score 660 if an edited text window 610 is easy to parse. Parsers often return a score with parser difficulty or cost. The parser used can be symbolic (treating words as symbols) or it can treat words as vectors and be based on a parametric function such as a neural network.

### Alternative Embodiment: General Language Model

In an alternative embodiment, the edit scorer 601 can use a general language model to help score edited text windows. A general language model gives the probability of the next word given the previous k words or given some abstract representation of the previous words. This model would not depend on what the user wrote. The general language model would be used by the edit scorer 601 to increase the edit correction score 660 if an edited text window 610 had a high probability and decrease the edit correction score 660 if an edited text window 610 had a low probability.

### Alternative Embodiment: Alternative Way to Compute Reduction in Translation Cost

Recall that the edit scorer 601 computes the translation cost reduction 640

$$translation cost reduction 640 = \frac{written translation cost 630 - edited translation cost 620}{written translation cost 630}$$

An alternative embodiment is to compute the edited translation cost 620 by setting both the text window 705 and the edited text window 760 to be the current edited text window. In other words, in this alternative embodiment, the edited translation cost is the cost of translating the edited text window to the edited text window itself.

### Alternative Embodiment: Thesaurus

The invention can also serve as a context-specific thesaurus. In this embodiment, the edited text window 760 is set to be equal to the text window 705. When the decoder 730 computes the probability distribution of symbols at focus position t, those symbols, or a subset of those symbols, may be shown to the user as possible alternative words for the symbol at focus position t in the edited text window 760, which is focus position t in the text window 705, since they are the same.

### Alternative Embodiment: Multi-Word Idiom Finder

Sometimes, a user may be looking for a perfect idiom. For example, the writer may want to say that one cause would have multiple good effects. She may have written “If we do X, then we can get A, B, and C” but not know how to finish the sentence. The invention can suggest to the user that the sentence be finished with “If we do X, then we can get A, B, and C in one fell swoop.”

This alternative embodiment can suggest this correction by adding a set of idioms gathered from an external source to the vocabulary as symbols. Once this is done, the multi-word idiom finder can work as a thesaurus described in the previous alternative embodiment. In this example, “in one fell swoop” would be mapped to a single symbol, and when the decoder 730 computed a probability distribution over symbols for the focus position following “C”, the symbol corresponding to “in one fell swoop” would be in that distribution with relatively high probability. It could then be shown to the user. The reason the symbol for “in one fell swoop” would have high probability at this focus position is that in the training data gathered in step 810 the idiom “in one fell swoop” will often follow sequences of words that have a similar text window abstract representation 720 to “If we do X, then we can get A, B, and C.”

### Alternative Embodiment: Search Text Correction

When one types a search query into a commerce site, one often is not sure of the correct terms to use to get what one wants. The present invention can be used to correct search queries by users to return what the user actually desires. In this alternative embodiment, the text window 705 is the query the user typed in, and the edited text window 760 is the edited query. Training requires data consisting of the original queries of users and associated correct queries that would have got the users what they actually wanted. One way to obtain these associated correct queries is to take the final query the user entered and use that as the correct query for the first query the user entered. Other methods for finding correct queries are included, such as automatically generated queries based on what the user purchased.

### CONCLUSION

While the description contains details, those details should not be interpreted as limiting. The invention can be embodied to run on a computer, handheld computer or network of computers, such as a home computer, a smartphone, or one or more networked computers in the cloud.

I claim:

1. An apparatus for checking grammar in text, comprising a processor or processors, a memory, and an application code, and further comprising:
an edit generator for generating edited versions of the text;
an edit scorer for scoring said edited versions for correctness, further comprising
an encoder comprising one or more parametric functions that converts the text into an abstract representation;
a decoder comprising one or more parametric functions that takes said abstract representation and computes the translation cost of translating the abstract representation into each of the edited versions of the text.

2. The apparatus of claim 1 wherein the edit scorer combines translation cost with text similarity.

3. The apparatus of claim 1 wherein the decoder uses a document context abstract representation.

4. The apparatus of claim 1 wherein the encoder converts phrases to symbols.

5. The apparatus of claim 1 wherein the encoder and the decoder are trained using data in which words have been replaced by similar words.

6. The apparatus of claim 1 wherein the encoder and decoder are trained using data in which common words are inserted.

7. The apparatus of claim 1 wherein the edit scorer uses a parser.

8. The apparatus of claim 1 wherein the edit scorer uses a language model.

9. The apparatus of claim 1 further comprising a mechanism for showing edited versions to the user that receives a parameter from the user that influences which edited versions to show.

10. The apparatus of claim 1 wherein the edit generator employs special pre-specified corrections.

11. The apparatus of claim 1 wherein the text is queries for items and the edit generator creates alternative queries, means for better queries.

12. A method for generating word replacements in a text, the method comprising:
encoding said text into an abstract representation;
decoding said abstract representation into words that could replace each word.

13. The method of claim 12, wherein
the set of symbols in a vocabulary includes multi-word idioms.

14. A method for checking grammar in a text, the method comprising:
generating a plurality of edited versions of the text;
scoring said edited versions by
encoding the text into an abstract representation; and
computing a translation cost for each of said edited versions by decoding said abstract representation into each of said edited versions.

15. The method of claim 14 wherein the scoring of edited versions combines translation cost with sentence similarity.

16. The method of claim 14 wherein the scoring of edited versions uses a document context abstract representation.

17. The method of claim 14 wherein the scoring of edited versions uses a parser.

18. The method of claim 14 wherein the scoring of edited versions uses a language model.

19. The method of claim 14 wherein the edited versions are generated using special pre-specified corrections.

20. The method of claim 14 wherein the transaction cost is computed by decoding some or all edited versions to themselves.
